(19) United States
(12) Patent Application Publication
(10) Pub. No.: US 2021/0054858 A1
(43) Pub. Date: Feb. 25, 2021

(54) ACTUATOR CONTROLLER

(71) Applicant: Control Components, Inc., Rancho Santa Margarita, CA (US)

(72) Inventor: Charles A. Hart, Rancho Santa Margarita, CA (US)

(21) Appl. No.: 16/547,944

(22) Filed: Aug. 22, 2019

(51) Int. Cl. F15B 15/20; F15B 21/08

(52) U.S. Cl. CPC F15B 15/20; F15B 21/08

(57) ABSTRACT

A control system for controlling the position of a piston within a cylinder includes a positioner, a digital controller, and one or more solenoid operated valves. The positioner may remain active at all times and contribute to control of the position of the piston. The digital controller may compare the actual position of the piston with a desired position of the piston and identify any deviation therebetween. When the deviation is above a prescribed threshold, the digital control may send a signal to the solenoid operated valve(s) to actuate the solenoid operated valve(s) to rapidly correct the deviation. As the deviation approaches zero, the digital controller may deactivate the solenoid operated valve(s) and the positioner may complete the correction.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

### 1. Technical Field

The present disclosure relates generally to fluid flow control, and more specifically to a control system including an analog positioner and at least one digitally controlled solenoid operated valve.

### 2. Description of the Related Art

Pneumatic control systems are commonly used for controlling one or more working valves within various industrial environments, such as power plants and refineries. The working valves may include an actuator piston which is moved within a cylinder to control the degree to which the working valve may be opened or closed. It may be desirable to quickly and repeatedly position an actuator piston to within thousandths of an inch to obtain a desirable flow characteristic by the working valve.

In order to quickly and precisely position the piston, the pneumatic control system may include a source of compressed air that is routed through a network of pneumatic lines. The compressed air is typically routed to a positioner which ultimately controls the flow of compressed air to and from the cylinder. The positioner may provide pneumatic signals in the form of compressed air, which may be routed to control valves or boosters. The boosters may be selectively opened and closed to regulate the flow of the compressed air to and from the cylinder. The boosters may receive the pneumatic signals and may be opened and closed by pneumatic pilots connected on either end of each booster. The pneumatic pilots of the boosters are connected to the positioner through signal lines. The boosters may also be connected to the source of compressed air through feed lines. The signal lines are typically of a smaller diameter than feed lines because they supply and exhaust compressed air into and out of the cylinder at relatively low flow rates. However, at higher flow rates, the positioner may provide a greater flow of compressed air into the signal lines with a pressure sufficient to actuate the pneumatic pilots of the volume boosters. The actuated boosters allow compressed air to flow from the larger diameter feed lines into and out of the cylinder at the higher rate.

The pneumatic control system may move the piston by forcing air into a first end of the cylinder while simultaneously withdrawing or exhausting air out of a second end of the cylinder in order to advance the piston along the length of the cylinder. Conversely, the pneumatic system may also force air into the second end of the cylinder while simultaneously exhausting air out of the first end of the cylinder in order to retract the piston in the opposite direction. By driving the air into alternate ends of the cylinder, the piston may be moved such that the shaft can be displaced in any position for doing useful work.

Although pneumatic control systems may be useful in controlling the position of the piston, there may be drawbacks and limitations associated therewith. For instance, existing pneumatic systems may be difficult to scale up for larger or faster actuators. Furthermore, conventional pneumatic systems may be associated with increased dead time, overshoot and oscillation, high steady state air consumption, as well as complexity and expense.

Accordingly, there is a need in the art for an improved control system that provides a simple, easily scalable alternative to conventional pneumatic control systems. Various aspects of the present disclosure address this particular need, as will be discussed in more detail below.

### BRIEF SUMMARY

In accordance with one embodiment of the present disclosure, there is provided a control system for controlling the position of a piston within a cylinder. The control system includes a positioner, a digital controller, and one or more solenoid operated valves. The positioner may remain active at all times and contribute to control of the position of the piston. The digital controller may compare the actual position of the piston with a desired position of the piston and identify any deviation therebetween. When the deviation is above a prescribed threshold, the digital control may send a signal to the solenoid operated valve(s) to actuate the solenoid operated valve(s) to rapidly correct the deviation. As the deviation approaches zero, the digital controller may deactivate the solenoid operated valve(s) and the positioner may complete the correction.

According to one embodiment, there is provided a control system for positioning a piston within a cylinder having first and second regions. The control system includes a compressed air source, and a positioner fluidly connected to the compressed air source for regulating flow of compressed air into and out of the first and second regions of the cylinder through respective positioner control lines. The control system further includes a controller capable of receiving a position signal indicative of an actual position of the piston within the cylinder and a control signal indicative of a desired position of the piston within the cylinder. The controller is configured to generate a boost signal when a comparison of the position signal and the control signal indicates a deviation between the actual position and the desired position that is above a predetermined magnitude. A solenoid operated valve is in electrical communication with the controller to receive the boost signal therefrom and is fluidly connected to the compressed air source for regulating flow of compressed air into and out of the first and second regions of the cylinder through respective solenoid control lines based on the boost signal received from the controller.

The solenoid operated valve may include an inlet port, a first control port, a second control port, a first exhaust port and a second exhaust port. The solenoid operated valve may be transitionable between a blocked position, a first actuated position and a second actuated position. In the blocked position, the inlet port may be fluidly blocked from the first control port and the second control port. In the first actuated position, the inlet port is fluidly connected to the first control port and blocked from the second control port. In the second actuated position, the inlet port may be fluidly connected to second control port and blocked form the first control port. The solenoid operated valve may be configured to place the second control port in fluid communication with the second exhaust port when the solenoid operated valve is in the first actuated position. The solenoid operated valve may be configured to place the first control port in fluid communication with the first exhaust port when the solenoid operated valve is in the second actuated position.

The position signal may be a digital position signal, and the controller may be configured to receive the digital position signal.

The control system may additionally include a piston position indicator positioned adjacent the cylinder and operative to sense the actual position of the piston within the cylinder and generate the position signal representative of the actual position. The piston position indicator may include pickup magnets mounted on the piston.

According to another embodiment, there is provided a method of controlling the position of a piston within a cylinder having first and second regions. The method includes receiving a first position signal at a controller, with the first position signal being representative of a first detected position of the piston within the cylinder. A positioner is actuated to control air flow in at least one positioner control pneumatic line extending between the positioner and the cylinder to urge the piston to move from the first detected position toward a desired position. The first detected position of the piston is compared with the desired position of the piston. A solenoid operated valve is transitioned from a normally blocked position to an actuated position when the comparison of the first detected position and the desired position indicates a deviation above a predetermined magnitude. Transitioning the solenoid operated valve to the actuated position causes air flow in at least one solenoid control pneumatic line extending between the solenoid operated valve and the cylinder to further urge movement of the piston from the first detected position toward the desired position.

The method may include the step of receiving a second position signal at the controller after the solenoid operated valve is transitioned to the actuated position, with the second position signal being representative of a second detected position of the piston within the cylinder. The method may additionally comprise the step of comparing the second detected position of the piston with the desired position of the piston. The method may further include transitioning the solenoid operated valve from the actuated position to the normally blocked position when the comparison of the second detected position of the piston with the desired position of the piston indicates a deviation below the predetermined magnitude. The method may also comprise actuating the positioner to control air flow in the at least one positioner control pneumatic line to urge the piston to move toward the desired position after the solenoid operated valve is transitioned from the actuated position toward the normally blocked position.

The receiving step may include receiving a digital position signal.

The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is a schematic diagram of a control system for an actuator in accordance with one embodiment of the present disclosure; and

FIG. 2 is a flow chart of the steps associated with an exemplary method of controlling the position of a piston within a cylinder.

Common reference numerals are used throughout the drawings and the detailed description to indicate the same elements.

### DETAILED DESCRIPTION

Referring now to the drawings, wherein the showings are for purposes of illustrating a preferred embodiment of the present disclosure only, and are not for purposes of limiting the same, there is depicted a schematic view of control system 10 for positioning a piston 12 within a cylinder 14. The control system 10 generally includes a positioner 16, a digital controller 18 and at least one solenoid operated valve 20. The positioner 16 may remain active at all times to control position of the piston 12 within the cylinder 14. When the digital controller 18 senses a predetermined deviation between a desired position of the piston 12 and an actual position of the piston 12, the digital controller 18 may send a signal to one or more solenoid operated valves 20 to activate the valve(s) 20 for rapidly correcting the deviation. Actuation of the valves 20 may cause additional air to be added or vented from the cylinder 14 as needed to achieve the desired movement of the piston 12. As the deviation approaches zero, the digital controller 18 may deactivate the solenoid operated valve(s) 20 and the positioner 16 may complete the correction.

The implementation of a digital controller 18 and solenoid operated valve(s) 20 allows the control system 10 to achieve high travel speeds of the piston 12 with precision positioning and control. Existing pneumatic control systems tend to be difficult to scale up for larger or faster actuators. An example of an existing pneumatic circuit control system is shown and described in U.S. Pat. No. 6,802,242, the contents of which are incorporated herein by reference. Existing pneumatic circuit control systems are also typically associated with increased dead time, overshoot, oscillation, high steady state air consumption, complexity and expense. The control system 10 disclosed herein may provide a simple, easily scalable, digital system that mitigates or eliminates many of the foregoing issues, while at the same time providing a user-friendly interface.

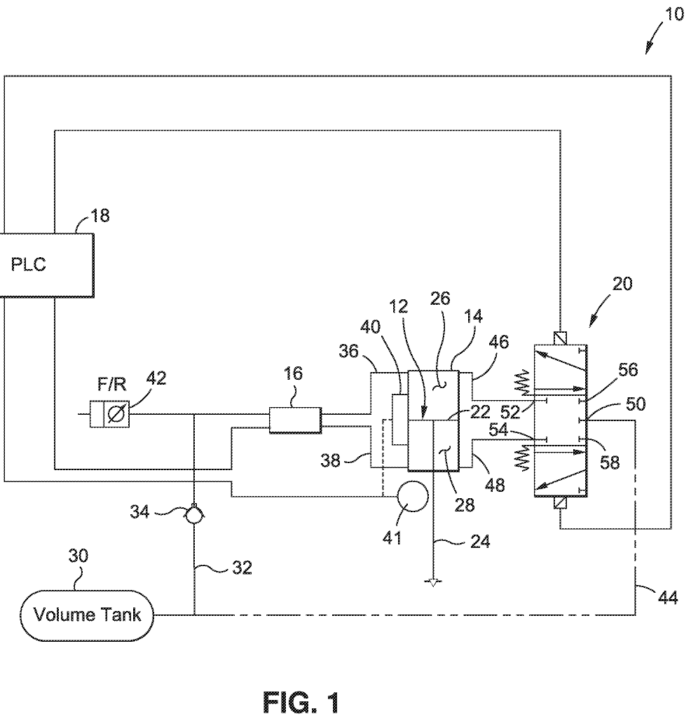

As shown in FIG. 1, the piston 12 includes a piston head 22 located within the cylinder 14, and a piston shaft 24 extending out of the cylinder 14. The piston head 22 divides the interior of the cylinder 14 into a first region 26 and a second region 28. The piston head 22 may create a fluid tight seal with the cylinder 14, such that the first region 26 is fluidly isolated from the second region 28. Furthermore, the respective volumes of the first and second regions 26, 28 may be selectively varied, which results in movement of the piston head 22 within the cylinder 14.

The position of the piston head 22 within the cylinder 14 may be controlled by selectively regulating the pressure within the first and second regions 26, 28. To move the piston head 22 in a downward direction based on the perspective shown in FIG. 1, a pressure differential is created, wherein the pressure in the first region 26 is greater than the pressure in the second region 28. Conversely, to move the piston head 22 in an upward direction based on the perspective shown in FIG. 1, a pressure differential is created, wherein the pressure in the first region 26 is less than the pressure in the second region 28. Air may be selectively added or vented from the first and second regions 26, 28 to create the desired pressure differential.

The system 10 may include a volume tank 30, e.g., a source of pressurized air, as well as plurality of pneumatic lines extending between the cylinder 14 and the volume tank 30 to facilitate the transfer of air into and out of the cylinder 14. A first pneumatic line 32 may extend between the volume tank 30 and the positioner 16. A check valve 34 may be disposed within the first pneumatic line 32 to allow flow of pressurized air from the volume tank 30 to the positioner 16 and prevent backflow, i.e., flow from the positioner 16 to the volume tank 30.

The positioner 16 is configured to regulate the flow of pressurized air into and out of the first and second regions 26, 28 of the cylinder 14 to control the position of the piston 12 within the cylinder 14. To that end, the system 10 may include a pair of positioner pneumatic lines 36, 38 extending between the positioner 16 and the first and second regions 26, 28 of the cylinder 14 to facilitate transfer of air between the positioner 16 and the cylinder 14.

Operation of the positioner 16 may be based on a detected position of the piston 12 within the cylinder 14. A piston position indicator 40 may be mounted adjacent the cylinder 14 for sensing an actual position of the piston 12 within the cylinder 14 and generating a piston position signal in response thereto. The piston position indicator 40 may be comprised of pickup magnets mounted on the piston 12, and a detector mounted on the cylinder 14, with the detector being capable of sensing a magnetic field strength associated with the pickup magnets. A transmitter 41 may communicate piston position signals to the controller 18. The transmitter 41 may be integral to the positioner 16 or separate from the positioner 16. The positioner 16 may be fitted with current-to-pressure transducers for 4-20 mA signal inputs supplied from the controller 18. As an alternative, feedback on the position of the piston 12 within the cylinder 14 may also be provided to the positioner 16 by a feedback arm mechanically connected to the piston 12. The positioner 16 converts the piston position signal to a pneumatic signal representative of a desired position of the piston 12. In response to the pneumatic signal, the flow of compressed air may be alternately directed into the first and second ends for respectively retracting and extending the piston 12 to correct for disparity between the actual position of the piston 12 and the desired position thereof.

The positioner 16 may be in fluid communication with a filter regulator 42 through a pneumatic line. The filter regulator 42 may reduce the pressurization level of the air supplied to the positioner 16 to a safe working level. In one embodiment, the filter regulator 42 may be preset to a maximum of 150 psi, although other maximum pressures may be set without departing from the spirit and scope of the present disclosure. The filter regulator 42 may also filter contaminants in the pressurized air, such as oil, and water, that may harm downstream components.

A second pneumatic line 44 may extend between the volume tank 30 and the solenoid operated valve 20 to deliver pressurized air thereto. The solenoid operated valve 20 may also be in electrical communication with the controller 18 to receive digital control signals therefrom. According to one embodiment, the solenoid operated valve 20 is a 5/3-way (i.e., 5 port 3 position), normally blocked valve, and may be in fluid communication with at least a pair of pneumatic solenoid control lines 46, 48 extending between the solenoid operated valve 20 and the cylinder 14. The ports on the solenoid operated valve 20 may include an inlet port 50, a first control port 52, a second control port 54, a first exhaust port 56 and a second exhaust port 58. The inlet port 50 is in fluid communication with the second pneumatic line 44 to place the solenoid operated valve 20 in fluid communication with the volume tank 30. A first solenoid control line 46 extends between the solenoid operated valve 20 and the first end of the cylinder 14, while a second solenoid control line 48 extends between the solenoid operated valve 20 and the second end of the cylinder 14.

The solenoid operated valve 20 is in electrical communication with the controller 18 to receive the boost signal therefrom which includes control instructions for regulating flow of compressed air into and out of the first and second regions 26, 28 of the cylinder 14 through the solenoid control lines 46, 48. Thus, actuation of the solenoid operated valve 20 may temporarily provide an increased flow rate of air into the cylinder 14, as well as an increased flow rate of air vented from the cylinder 14 to effectuate rapid movement of the piston 12 within the cylinder 14.

The solenoid operated valve 20 may be transitionable between a blocked position, a first actuated position, and a second actuated position. In the blocked position, the inlet port 50 may be fluidly blocked from the first control port 52 and the second control port 54. As such, the air from the volume tank is blocked from the first and second control ports 52, 54. In the first actuated position, the inlet port 50 is fluidly connected to the first control port 52 and blocked from the second control port 54. As a result, pressurized air may be delivered to the first solenoid control line 46 though the first control port 52 when the solenoid operate valve 20 is in the first actuated position. In the second actuated position, the inlet port 50 may be fluidly connected to second control port 54 and blocked form the first control port 52. Thus, pressurized air may be delivered to the second solenoid control line 48 though the second control port 54 when the solenoid operate valve 20 is in the second actuated position. The solenoid operated valve 20 may be configured to place the second control port 54 in fluid communication with the second exhaust port 58 when the solenoid operated valve 20 is in the first actuated position to allow for venting of the cylinder 14 through the second exhaust port 58. The solenoid operated valve 20 may be configured to place the first control port 52 in fluid communication with the first exhaust port 56 when the solenoid operated valve 20 is in the second actuated position to allow for venting of the cylinder 14 through the first exhaust port 56.

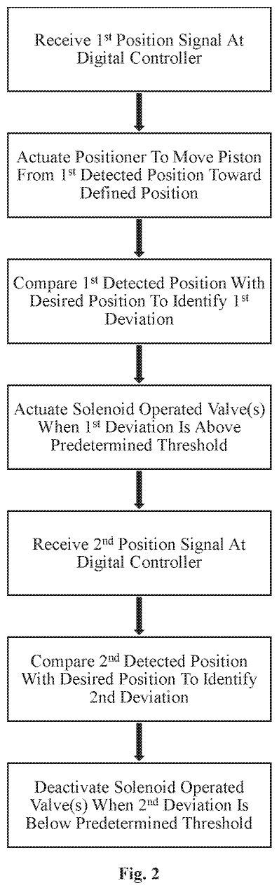

With the basic structure described above, and referring now to FIGS. 1 and 2, the following discussion relates to an exemplary operation of the control system 10. Control of the position of the piston 12 within the cylinder 14 may entail receiving a first position signal may at the controller 18, with the first position signal being representative of a first detected position of the piston 12 within the cylinder 14. The positioner 16 may be actuated to control air flow in the positioner control pneumatic lines 36, 38 extending between the positioner 16 and the cylinder 14 to urge the piston 12 to move from the first detected position toward a desired position, which may be preprogrammed into the controller 18. The controller 18 may compare the first detected position of the piston 12 with the desired position of the piston 12. The solenoid operated valve 20 may be transitioned from a normally blocked position to an actuated position when the comparison of the first detected position and the desired position indicates a deviation above a predetermined magnitude. Transitioning the solenoid operated valve 20 to the actuated position may cause air flow in the solenoid control pneumatic lines 46, 48 extending between the solenoid operated valve 20 and the cylinder 14 to further urge movement of the piston 12 from the first detected position toward the desired position. For instance, air may flow toward the cylinder 14 in one solenoid control pneumatic line 46, 48 and away from the cylinder 14 in the other solenoid control pneumatic line 46, 48 to achieve the desired movement of the piston 12.

A second position signal may be received at the controller 18 after the solenoid operated valve 20 is transitioned to the actuated position, with the second position signal being representative of a second detected position of the piston 12 within the cylinder 14. The controller 18 may compare the second detected position of the piston 12 with the desired position of the piston 12. The solenoid operated valve 20 may be transitioned from the actuated position to the normally blocked position when the comparison of the second detected position of the piston 12 with the desired position of the piston 12 indicates a deviation below the predetermined magnitude. The positioner 16 may be actuated to control air flow in the at least one positioner control pneumatic line to urge the piston 12 to move toward the desired position after the solenoid operated valve 20 is transitioned from the actuated position toward the normally blocked position.

The use of digital controls and solenoid operated valves within the control system 10 allows for easy programmability and precision. Furthermore, such digital components may not be as sensitive to temperature variations as convention pneumatic control systems. Furthermore, the use of solenoid operated valves mitigates some of the deficiencies associated with volume boosters in conventional pneumatic control systems. Along these lines, conventional volume boosters may have practical flow limitations of approximately Cv 17. Although conventional volume boosters may be installed in parallel, conventional positioners may only control three such volume boosters for a total Cv of 51. Solenoid operated valves may not be hindered by such limitations and may be used to control air operated valves with Cv's up to 40 each, which can also be installed in parallel groups of four or more to achieve a Cv of 160+.

The particulars shown herein are by way of example only for purposes of illustrative discussion and are not presented in the cause of providing what is believed to be most useful and readily understood description of the principles and conceptual aspects of the various embodiments of the present disclosure. In this regard, no attempt is made to show any more detail than is necessary for a fundamental understanding of the different features of the various embodiments, the description taken with the drawings making apparent to those skilled in the art how these may be implemented in practice.

1. A control system for positioning a piston, the control system comprising:
a cylinder having first and second regions, the cylinder being sized to have at least a portion of the piston located in the cylinder;
a pair of positioner pneumatic control lines fluidly connected to respective ones of the first and second regions of the cylinder;
a pair of solenoid pneumatic control lines fluidly connected to respective ones of the first and second regions of the cylinder;
a compressed air source in fluid communication with the cylinder;
a positioner fluidly connected to the compressed air source and fluidly connected to the first and second regions of the cylinder via the pair of positioner pneumatic control lines for regulating flow of compressed air into and out of the first and second regions of the cylinder;
a controller capable of receiving a position signal indicative of an actual position of the piston within the cylinder and a control signal indicative of a desired position of the piston within the cylinder, the controller being configured to generate a boost signal when a comparison of the position signal and the control signal indicates a deviation between the actual position and the desired position that is above a predetermined magnitude;
a solenoid operated valve in electrical communication with the controller to receive the boost signal therefrom and fluidly connected to the compressed air source and fluidly connected to the first and second regions of the cylinder via the pair of solenoid pneumatic control lines for regulating flow of compressed air into and out of the first and second regions of the cylinder based on the boost signal received from the controller.

2. The control system recited in claim 1, wherein the solenoid operated valve includes an inlet port, a first control port, a second control port, a first exhaust port and a second exhaust port.

3. The control system recited in claim 2, wherein the solenoid operated valve is transitionable between a blocked position, a first actuated position and a second actuated position, in the blocked position, the inlet port is fluidly blocked from the first control port and the second control port, in the first actuated position, the inlet port is fluidly connected to the first control port and blocked from the second control port, and in the second actuated position, the inlet port is fluidly connected to second control port and blocked form the first control port.

4. The control system recited in claim 3, wherein the solenoid operated valve is configured to place the second control port in fluid communication with the second exhaust port when the solenoid operated valve is in the first actuated position.

5. The control system recited in claim 4, wherein the solenoid operated valve is configured to place the first control port in fluid communication with the first exhaust port when the solenoid operated valve is in the second actuated position.

6. The control system recited in claim 1, wherein the position signal is a digital position signal, and the controller is configured to receive the digital position signal.

7. The control system recited in claim 1, further comprising a piston position indicator positioned adjacent the cylinder and operative to sense the actual position of the piston within the cylinder and generating the position signal representative of the actual position.

8. The control system recited in claim 7, wherein the piston position indicator includes pickup magnets mounted on the piston.

9. A method of controlling the position of a piston within a cylinder having first and second regions, the method comprising the steps of:
receiving a first position signal at a controller, the first position signal being representative of a first detected position of the piston within the cylinder;
actuating a positioner to control air flow in at least one of a pair of positioner control pneumatic lines extending between the positioner and the cylinder to urge the piston to move from the first detected position toward a desired position;
comparing the first detected position of the piston with the desired position of the piston; and
transitioning a solenoid operated valve from a normally blocked position to an actuated position when the comparison of the first detected position and the desired position indicates a deviation above a predetermined magnitude, transitioning the solenoid operated valve to the actuated position causing air flow in at least one of a pair of solenoid control pneumatic lines extending between the solenoid operated valve and the cylinder to further urge movement of the piston from the first detected position toward the desired position.

10. The method recited in claim 9, further comprising the step of receiving a second position signal at the controller after the solenoid operated valve is transitioned to the actuated position, the second position signal being representative of a second detected position of the piston within the cylinder.

11. The method recited in claim 10, further comprising the step of comparing the second detected position of the piston with the desired position of the piston.

12. The method recited in claim 11, further comprising the step of transitioning the solenoid operated valve from the actuated position to the normally blocked position when the comparison of the second detected position of the piston with the desired position of the piston indicates a deviation below the predetermined magnitude.

13. The method recited in claim 12, further comprising the step of actuating the positioner to control air flow in the at least one positioner control pneumatic line to urge the piston to move toward the desired position after the solenoid operated valve is transitioned from the actuated position toward the normally blocked position.

14. The method recited in claim 9, wherein the receiving step includes receiving a digital position signal.

15. A method of controlling the position of a piston within a cylinder having first and second regions, the method comprising the steps of:
receiving a first position signal at a controller, the first position signal being representative of a first detected position of the piston within the cylinder;
comparing the first detected position of the piston with the desired position of the piston; and
transitioning a solenoid operated valve from a normally blocked position to an actuated position when the comparison of the first detected position and the desired position indicates a deviation above a predetermined magnitude, transitioning the solenoid operated valve to the actuated position causing air flow in at least one of a pair of solenoid control pneumatic lines extending between the solenoid operated valve and the cylinder to further urge movement of the piston from the first detected position toward the desired position.

16. The method recited in claim 15, further comprising the step of receiving a second position signal at the controller after the solenoid operated valve is transitioned to the actuated position, the second position signal being representative of a second detected position of the piston within the cylinder.

17. The method recited in claim 16, further comprising the step of comparing the second detected position of the piston with the desired position of the piston.

18. The method recited in claim 17, further comprising the step of transitioning the solenoid operated valve from the actuated position to the normally blocked position when the comparison of the second detected position of the piston with the desired position of the piston indicates a deviation below the predetermined magnitude.

19. The method recited in claim 15, wherein the receiving step includes receiving a digital position signal.
